(19) United States
(12) Patent Application Publication
(10) Pub. No.: US 2026/0072568 A1
(43) Pub. Date: Mar. 12, 2026

(54) METHOD AND SYSTEM FOR DYNAMIC CONVERSATIONAL ORDERING

(71) Applicant: Toast, Inc., Boston, MA (US)

(72) Inventors: Jennifer J. Teti, Bedford, MA (US); Dusan Koljensic, Arlington, MA (US)

(73) Assignee: Toast, Inc., Boston, MA (US)

(21) Appl. No.: 18/827,501

(22) Filed: Sep. 6, 2024

(51) Int. Cl. G06F 3/0482; G06F 3/04817; G06F 3/04842; G06F 3/0485; G06F 3/04883

(52) U.S. Cl. CPC G06F 3/0482; G06F 3/04817; G06F 3/04842; G06F 3/0485; G06F 3/04883

(57) ABSTRACT

A computer-implemented method for displaying a digital menu on a point-of-sale device, the method including: on a touchscreen display, displaying selectable icons as a single virtual page, where: the selectable icons correspond to menu tier elements in menu tiers according to a menu tier hierarchy; and the touchscreen display includes scrolling mechanisms to display one or more of the selectable icons that are not initially visible on the single virtual page; selecting one of the selectable icons in a menu tier for an order, where the menu tier is not a highest-level tier in the menu tier hierarchy; and responsive to selection of the one of the selectable icons, modifying the single virtual page by replacing one or more of the selectable icons in higher-level and lower-level menu tiers relative to the menu tier with new replacement icons that correspond to the one of the selectable icons in the menu tier hierarchy.

### RELATED APPLICATIONS

This application is related to the following U.S. patent application, which has a common assignee and common inventors, the entirety of which is herein incorporated by reference.

| SERIAL | FILING | |
|---|---|---|
| NUMBER | DATE | TITLE |
| (̅T̅S̅T̅.̅0̅1̅8̅7̅)̅ | — | DYNAMIC CONVERSATIONAL ORDERING |
| | | METHOD AND SYSTEM |

### BACKGROUND OF THE INVENTION

### Field of the Invention

This invention relates in general to the field of point of sales systems, and more particularly to a method and system that dynamically supports a conversational style of placing an order for goods or services.

### Description of the Related Art

Twenty years ago, patrons in a retail establishment placed their orders for goods and services with employees of the establishment. In the case of retail stores, the patrons transported what they wanted to purchase to a checkout station where a checkout attendant would generate an invoice (presented to the patron either by an electronic display or by paper) and process payment for the purchase using point-of-sale terminal. In the case of restaurants, bars, travel means, sporting and entertainment events, and other venues where patrons are seated, employees would take the patrons' orders where they were seated. The orders were generally taken by hand and then the employees would enter the orders into a collocated point-of-sale terminal. When prepared, the ordered goods were brought to the patrons by the employees. The employees would then bring a bill in paper form to the patrons and the patrons would provide payment to the employees or they would pay at a point-of-sale terminal configured to collect payments.

This process for placing and paying for ordered good is a workable process given that frequent mistakes occur in orders and payments that result from miscommunication between the employees and the patrons; however, this process is expedient considering that many patrons speak in common conversational language to place orders from a goods listing or menu of goods. This is because the employees (“servers”) are very familiar with the listed goods along with the manner in which the goods are listed and they are thus able to understand nuances of a conversation and guide the patrons as they place their orders. For example, consider that server in a restaurant approaches a patron who is viewing a menu, and the patron asks first about vegan options. Because the server is familiar with the appetizers, entrees, sides, and desserts on the menu that are vegan options, the server may direct the patron's attention to those options on the menu, thus providing some efficiency to the ordering process.

In more recent years, techniques for presenting a list of items for order and for placing an order for one or more of the items has changed from the use of paper lists (“menus”) to the use of portable computers with touchscreen displays. This is primarily because the orders placed are immediately communicated to computers in an order fulfillment area and the order is prepared and fulfilled via human or automated means, thus reducing the transport time for orders to be placed and routed to the fulfillment area and also providing a consistent presentation and order-taking mechanism that is not subject to how an employ writes down an order and how that order is communicated to fulfillment staff. Yet, as one skilled in the art will appreciate, a point-of-sale terminal only has a single screen as opposed to, for instance, pages and pages of a restaurant menu. Whether the terminal is attended by a server or fixed at a table (as in a tableside self-ordering kiosk), the establishment's challenge is in presenting an understandable and usable presentation of the goods list to a patron or a server so that orders can be placed and fulfilled without undue delay. Unfortunately, present-day techniques for goods listing and order placement using these point-of-sale terminals tend to add delay to the process rather than eliminate delay. This is because a typical present-day digital point-of-sale terminal display lists goods in a hierarchical order and does not readily recognize conversational ordering styles as are described above.

Consider a typical restaurant menu hierarchy that has several menu groups (e.g., appetizers, entrees, and drinks) and each menu group has menu subgroups (e.g., beef, chicken, fish, and vegetarian in the entrees group). Each menu subgroup has menu items (e.g., roast chicken, fried chicken). Some of the menu items have numerous modifier groups (e.g., sauces, toppings) and each modifier group has corresponding modifiers (e.g., lobster topping, crab topping, oyster topping). How are these elements best presented to a patron/server so that orders are easily placed without the introduction of delay? To place an order, a server/patron may select “Entrees” on a displayed page that then displays the subgroups “Beef,” “Chicken,” etc. If “Beef” is selected, then another pages displaying menu items from the “Beef” subgroup is displayed. When a menu item is selected, then another page is displayed showing modifier groups for the menu item and when a modifier group is selected, another page is displayed showing modifiers within that modifier group. Consequently, a patron/server must navigate multiple display pages to order a single item, and when the patron/server desires to order another item or change the item ordered, the process starts over again.

Some restaurants meet the above challenges by designing and deploying custom menu display and ordering solutions that provide for display of mixed menu tiers such as placing most ordered menu items from most ordered menu groups on a single display screen and placing four menu items from each menu subgroup on the single screen. Though such an optimization may be sufficient for a given restaurant or restaurant chain, it is not scalable nor sufficient to apply as a general solution for different types of restaurants and restaurant chains that have differing menu hierarchies.

Another problem with present-day menu display and ordering mechanisms is that guests don't always order according to menu hierarchy, namely specifying a menu group first, menu subgroup second, menu item third, etc., as is described above in the conversational style where a guest wants vegan items and “vegan” may be lower down in the menu hierarchy, perhaps even as a modifier group for certain menu items. In this case, single-page hierarchical menuing and ordering systems become difficult to navigate at best.

Therefore, what is needed are techniques and mechanisms the enable unconstrainted display content for digital menu displays that in addition facilitate rapid and efficient entry of orders by a server and/or guest.

What is also needed are methods and system for display of hierarchical digital menus that can easily be adapted to a multitude of different restaurant fares and that is scalable for differing individual and chain restaurant menus.

What is additionally needed is a conversational menuing method and system that dynamically adapts to support conversational ordering styles and that supports changes in orders.

What is furthermore needed is a digital menu display mechanism that presents a complete virtual set of modifiers for a menu item that can be scrolled by a server/guest.

What is moreover needed is a digital menu display that adapts the display of both upper and lower hierarchical menuing levels when a given group, subgroup, menu item, modifier group, or modifier is selected.

What is additionally needed is a digital menu display and ordering system that provides for identification of menu tiers that cannot be ordered due to inventory and or class restrictions (e.g., no beef entries displayed for “vegan” modifier group).

What is also needed is a conservational menu display and ordering method and system that employs one or more processors to analyze historical orders for a restaurant or restaurant chain and that dynamically rearranges and/or preselects class icons on a menu display to place and preselect class icons for those most ordered tiers in prominent positions to enable rapid ordering by a server and/or guest.

### SUMMARY OF THE INVENTION

The present invention, among other applications, is directed to solving the above-noted problems and addresses other problems, disadvantages, and limitations of the prior art by providing a superior technique for displaying menus from which guests place orders for goods and/or services, which is typically done in a conversational manner. In one embodiment, a computer-implemented method for displaying a digital menu on a point-of-sale (POS) device is provided, the method including: on a touchscreen display of the POS device, displaying first selectable icons as a single virtual page, where: the first selectable icons correspond to menu tier elements in menu tiers according to a menu tier hierarchy; and the touchscreen display includes scrolling mechanisms to display one or more of the first selectable icons that are not initially visible on the single virtual page; selecting one of the first selectable icons in a first menu tier for an order, where the first menu tier is not a highest-level tier in the menu tier hierarchy; and responsive to selection of the one of the first selectable icons, modifying the single virtual page by replacing one or more of the first selectable icons in higher-level and lower-level menu tiers relative to the first menu tier with second selectable icons that correspond to the one of the first selectable icons in the menu tier hierarchy.

One aspect of the present invention contemplates a computer-readable storage medium storing instructions that, when executed by a computer, cause the computer to perform a method for displaying a digital menu on a point-of-sale (POS) device, the method including: on a touchscreen display of the POS device, displaying first selectable icons as a single virtual page, where: the first selectable icons correspond to menu tier elements in menu tiers according to a menu tier hierarchy; and the touchscreen display includes scrolling mechanisms to display one or more of the first selectable icons that are not initially visible on the single virtual page; selecting one of the first selectable icons in a first menu tier for an order, where the first menu tier is not a highest-level tier in the menu tier hierarchy; and responsive to selection of the one of the first selectable icons, modifying the single virtual page by replacing one or more of the first selectable icons in higher-level and lower-level menu tiers relative to the first menu tier with second selectable icons that correspond to the one of the first selectable icons in the menu tier hierarchy.

Another aspect of the present invention envisages a computer program product for displaying a digital menu on a point-of-sale (POS) device, the computer program product including: a computer readable non-transitory storage medium having computer readable program code stored thereon, the computer readable program code including: program instructions to, on a touchscreen display of the POS device, display first selectable icons as a single virtual page, where: the first selectable icons correspond to menu tier elements in menu tiers according to a menu tier hierarchy; and the touchscreen display includes scrolling mechanisms to display one or more of the first selectable icons that are not initially visible on the single virtual page; program instructions to select one of the first selectable icons in a first menu tier for an order, where the first menu tier is not a highest-level tier in the menu tier hierarchy; and program instructions to, responsive to selection of the one of the first selectable icons, modify the single virtual page by replacing one or more of the first selectable icons in higher-level and lower-level menu tiers relative to the first menu tier with second selectable icons that correspond to the one of the first selectable icons in the menu tier hierarchy.

### BRIEF DESCRIPTION OF THE DRAWINGS

These and other objects, features, and advantages of the present invention will become better understood with regard to the following description, and accompanying drawings where:

FIG. 1 is a block diagram illustrating a dynamic conversational menu display and ordering system according to the present invention;

FIG. 2 is a block diagram depicting a backend server according to the system of FIG. 1;

FIG. 3 is a diagram featuring an exemplary dynamic digital menu display according to the present invention;

FIG. 4 is a diagram showing an exemplary populated menu display according to the present invention as may be applied to a guest's forward conversational ordering manner;

FIG. 5 is a diagram showing an exemplary populated menu display according to the present invention as may be applied to a guest's reverse conversational ordering manner;

FIG. 6 is a diagram showing an exemplary populated menu display according to the present invention as modified via a processor's analysis of items most ordered from one or more corresponding restaurant menus;

FIG. 7 is a block diagram showing a point-of-sale terminal according to the present invention;

FIG. 8 is a flow diagram illustrating a dynamic conversational menu display and ordering method according to the present invention as may be applied to a guest's forward conversational ordering manner;

FIG. 9 is a flow diagram illustrating a dynamic conversational menu display and ordering method according to the present invention as may be applied to a guest's reverse conversational ordering manner; and

FIG. 10 is a flow diagram featuring a dynamic conversational menu display and ordering method according to the present invention as modified via a processor's analysis of items most ordered from one or more corresponding restaurant menus.

### DETAILED DESCRIPTION

Exemplary and illustrative embodiments of the invention are described below. It should be understood at the outset that although exemplary embodiments are illustrated in the figures and described below, the principles of the present disclosure may be implemented using any number of techniques, whether currently known or not. In the interest of clarity, not all features of an actual implementation are described in this specification, for those skilled in the art will appreciate that in the development of any such actual embodiment, numerous implementation specific decisions are made to achieve specific goals, such as compliance with system-related and business-related constraints, which vary from one implementation to another. Furthermore, it will be appreciated that such a development effort might be complex and time-consuming, but would nevertheless be a routine undertaking for those of ordinary skill in the art having the benefit of this disclosure. Various modifications to the preferred embodiment will be apparent to those skilled in the art, and the general principles defined herein may be applied to other embodiments. Therefore, the present invention is not intended to be limited to the particular embodiments shown and described herein, but is to be accorded the widest scope consistent with the principles and novel features herein disclosed.

The present invention will now be described with reference to the attached figures. Various structures, systems, and devices are schematically depicted in the drawings for purposes of explanation only and so as to not obscure the present invention with details that are well known to those skilled in the art. Nevertheless, the attached drawings are included to describe and explain illustrative examples of the present invention. Unless otherwise specifically noted, articles depicted in the drawings are not necessarily drawn to scale.

The words and phrases used herein should be understood and interpreted to have a meaning consistent with the understanding of those words and phrases by those skilled in the relevant art. No special definition of a term or phrase (i.e., a definition that is different from the ordinary and customary meaning as understood by those skilled in the art) is intended to be implied by consistent usage of the term or phrase herein. To the extent that a term or phrase is intended to have a special meaning (i.e., a meaning other than that understood by skilled artisans) such a special definition will be expressly set forth in the specification in a definitional manner that directly and unequivocally provides the special definition for the term or phrase. As used in this disclosure, “each” refers to each member of a set, each member of a subset, each member of a group, each member of a portion, each member of a part, etc.

Applicants note that unless the words “means for” or “step for” are explicitly used in a particular claim, it is not intended that any of the appended claims or claim elements are recited in such a manner as to invoke 35 U.S.C. § 112(f).

### Definitions

Central Processing Unit (CPU): The electronic circuits (i.e., “hardware”) that execute the instructions of a computer program (also known as a “computer application,” “application,” “application program,” “app,” “computer program,” or “program”) by performing operations on data, where the operations may include arithmetic operations, logical operations, or input/output operations. A CPU may also be referred to as a “processor.”

Module: As used herein, the term “module” may refer to, be part of, or include an application specific integrated circuit (ASIC), an electronic circuit, a processor (shared, dedicated, or group) and/or memory (shared, dedicated, or group) that execute one or more computer programs, a combinational logic circuit, and/or other suitable components that provide the described functionality.

Internet: The Internet (also referred to as world wide web, web, interwebs, or internet cloud) is a global wide area network connecting computers throughout the world via a plurality of high-bandwidth data links which are collectively known as the Internet backbone. The Internet backbone may be coupled to Internet hubs that route data to other locations, such as web servers and Internet Service Providers (ISPs). The ISPs route data between individual computers and the Internet and may employ a variety of links to couple to the individual computers including, but not limited to, cable, DSL, fiber, Wi-Fi, radio links, and satellite links to enable the individual computers to transmit and receive data over in the form of email, web page services, social media, etc.

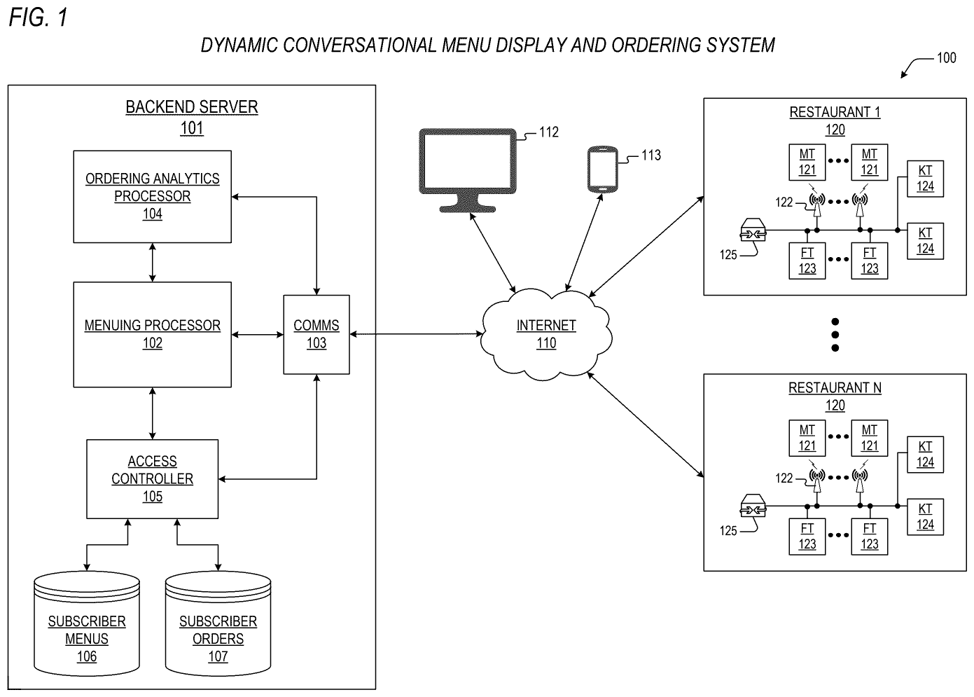

In view of the above background discussion present-day point-of-sale (POS) systems along with the techniques employed to display ordering options for selection by a server or a retail guest, a discussion of the present invention will now be presented with reference to FIGS. 1-10.

Turning to FIG. 1, a block diagram is presented illustrating a dynamic conversational menu display and ordering system 100 according to the present invention. The system 100 may include a plurality of restaurants 120 that each subscribe to a restaurant point-of-sale subscription service for automation of restaurant point-of-sale (POS) services including, but not limited to, displaying of menus, advertising of menu items, ordering of menu items by restaurant guests, routing of ordered items to kitchen stations for preparation, sequencing of ordering items through kitchens, capture and historical tracking of metadata corresponding to each order (e.g., staff assigned for preparation of ordered items; day, date, time, and season; kitchen conditions; short-term kitchen work load; true time for preparation of ordered items; dining option for order (e.g., takeout, dine in); pending incoming orders; local weather; and significant events, internal or external, that may impact order preparation times), acceptance of payments by guests and processing of those payments through corresponding credit card networks and financial institutions, and payment of charged amounts to the restaurants themselves. In one embodiment, the system 100 according to the present invention may comprise over 30,000 restaurants 120 of different types and levels of service that fulfill over 50,000,000 orders every month.

The restaurants 120 are coupled via the internet 110 to a backend server 101, that is not on-premises with the restaurants 120. The restaurants 120 do not comprise any type of device that functions as a local server to perform the operations noted herein, but rather couple to the internet 110 through one or more internet gateway devices 125. The restaurants 120 may comprise one or more wireless access points 122 that are hard-wired to the gateway 125 and that provide for wireless communications over one or more wireless networks that include, but are not limited to, Wi-Fi networks, Bluetooth networks, near-field communication (NFC) networks, infrared networks, IEEE 802.15.4 networks, Zigbee radio networks, fiber optic networks, cellular communication networks (e.g., 3G, 4G, LTE, 5G, etc.), and ad hoc networks with other devices such as a smart phones and smart tablets that may be on-premise. The restaurants 120 may further comprise one or more mobile POS terminals 121 that are coupled to one or more of the wireless access points 122 and that may be employed for seating, tableside ordering, and guest payments. The restaurants 120 may additionally include one or more fixed POS terminals 123 that are hard-wired to the gateway 125 over a hard-wired communication network such as, but not limited to, Ethernet networks, local area networks, fiber optic networks, and the like. The mobile POS terminals 121 and fixed POS terminals 123 may be individually configured to comport with intended function (e.g., guest seating, order entry by servers, order entry by guests (e.g., kiosk configuration), order fulfillment, payment processing, owner engagement, order feedback, etc.), or they may be configured similarly.

The restaurants 120 may moreover comprise one or more kitchen fulfillment terminals 124 that are typically hard-wired to the gateway 125, though the present invention contemplates wireless connections to the one or more kitchen fulfillment terminals 125 via wireless access points 122.

The backend server 101 many comprise communications circuits 103 that are coupled to the internet 110 and to a menuing processor 102, a database access controller 105, and an ordering analytics processor 104. The menuing processor 102 is coupled to the ordering analytics processor 104 and the access controller 105. The access controller 105 is coupled to a subscriber menus database 106 and a subscriber orders database 107. The backend server 101 is also operationally coupled via the internet 110 to one or more guest laptop/desktop computers 112 and one or more guest smart devices 113 (e.g., smart phone or tablet.

In operation, the mobile POS terminals 121, fixed POS terminals 123, and kitchen fulfillment terminals 124 in each of the restaurants 120 communicate with the backend server 101 through their respective gateways 125 to perform the functions of displaying menus for guest selection, entry of menu items selected by guests, upselling of menu items to guests, routing of ordered menu items to kitchen staff for preparation, sequencing of ordered menu items through kitchen stations, capture and historical tracking of menu items ordered by guest along with metadata corresponding to each order, acceptance of payments by guests and processing of those payments through corresponding credit card networks and financial institutions, and payment of charged amounts to the restaurants themselves, thus providing for efficient operation of the restaurants 120. One or more of the mobile POS terminals 121 and fixed POS terminals 123 within a given restaurant may be employed to enter and take payment for portions of an individual order placed anywhere within the restaurant, where synchronization of order states is performed by the backend server 101, whereby synchronized states of all orders within the given restaurant 120 are transmitted by the backend server 101 to all POS terminals 121, 123 within the given restaurant 120.

For each order placed within the given restaurant 120, the backend server 101 may transmit messages over the internet 110 to one or more of the given restaurant's kitchen fulfillment terminals 124 to efficiently accomplish preparation of individual items within an order and to provide for order sequencing and coursing. For example, the backend server may route messages to a first kitchen fulfillment terminal 124 for preparation of salad courses, a second kitchen fulfillment terminal 124 for preparation of meat items, a third kitchen fulfillment terminal 124 for preparation of sides, and a fourth kitchen fulfillment terminal 124 that functions as an expediter terminal 124 for all orders within the restaurant 124. In addition to performing these noted functions, the kitchen fulfillment terminals 124 according to the present invention also capture and transmit metadata corresponding to each of the orders placed and fulfilled within a given restaurant 120. As noted above, this metadata includes, but is not limited to, actual order preparation time; actual preparation time for items within an order; staff assigned for preparation of ordered items; day, date, time, and season corresponding to the order; kitchen conditions during preparation of the order; short-term kitchen work load during preparation of the order; dining option for the order (e.g., takeout, dine in, delivery); pending incoming orders; local weather; and significant events, internal or external, that may impact preparation of the order (e.g., arrival of 40 guests in a single reservation at order placement time, end of concert or sporting event nearby, etc.). All of the metadata corresponding to orders are transmitted to the backend server 101 over the internet 110 and the backend server 101 directs the access controller 105 to store the metadata in the subscriber orders database 107, where it is associated with the restaurant 120 that entered and fulfilled the order. Accordingly, the subscriber order database 107 may comprise historical ground truth order fulfillment data and metadata corresponding to all orders that are fulfilled by each of the subscriber restaurants.

The subscriber menus database 106 comprises all of the menu items that are employed by each of the subscriber restaurants 106. In one embodiment, the subscriber menus database 106 and the subscriber orders database 107 may be separate databases 106, 107. Another embodiment contemplates combination of this data into a single subscriber database. An additional embodiment contemplates databases 106, 107 that are not on-premises with the backend server 101, but which are accessed via communications over the internet 110, such as those provided by Amazon Web Services.

In one embodiment, guests may employ one of the one or more laptop or desktop computers 112 to remotely place orders within a given restaurant for pickup or delivery. Likewise, guests may employ one of the one or more smart devices 113 to remotely place orders within a given restaurant 120 for pickup or delivery. In one embodiment, the laptop/desktop computers 112 and smart devices 113 may be executing proprietary thin client application programs that execute to display menus, provide for order entry and predicted preparation times, and provide for payment and feedback. Another embodiment contemplates display of menus, order entry, display of predicted preparation times, and payment via web-based browsers executing on the computers 112 and smart devices. A further embodiment envisages 3rd-party application programs executing on the computers 112 and smart devices 113 that communicate with the backend server 101 via one or more application programming interfaces (API's) and that communicate with delivery services such as, UberEats, DoorDash, GrubHub, Postmates, and the like.

As described above, the system 100 according to the present invention is employed by subscriber restaurants to perform the functions of displaying of menus, ordering of menu items by guests, upselling of menu items to guests, routing of ordered items to kitchen staff for preparation, sequencing of ordering items through kitchens, capture and historical tracking of metadata corresponding to each order, acceptance of payments by guests and processing of those payments through corresponding credit card networks and financial institutions, and payment of charged amounts to the restaurants themselves, where the backend server 101 directs the terminals 121, 123, 124 via messaging to execute one or more of these functions, and where the backend server 101 also synchronizes all of the terminals 121, 123, 124 within a restaurant 120 so that they reflect the current status and state of all orders in process within the restaurant 120, and where the backend server 101 accesses the subscriber menus database 106 to configure all of the terminals 121, 123, 124 with current menu items for the restaurant 120, and where the backend server 101 stores all fulfilled orders along with corresponding metadata in the subscriber orders database 107. As alluded to earlier, though these functions are essential to efficient operation of the subscriber restaurants, the present disclosure focuses on an area of significant importance to restaurant management: optimization of menu displays on the mobile POS terminals 121 and fixed POS terminals 123 to enable placement of orders within a restaurant 120 more rapidly and accurately than that which has heretofore been provided.

As one skilled in the art will appreciate, a typical restaurant menu and its associated hierarchy is not straightforward, and the manner of presentation of that menu to guests and/or servers waiting on those guests is a challenge to restaurant efficiency. This is because a typical menu today may comprise several menu groups such as, but not limited to, appetizers, second courses, salads, entrees, sides, drinks, desserts, and combination order. Each menu group may comprise numerous menu subgroups (e.g., beef, chicken, fish, and vegetarian in the entrees group). Each menu subgroup may comprise numerous menu items (e.g., steak au poivre, filet mignon, and chopped steak in the beef subgroup. Each menu item may have numerous modifier groups (e.g., sauces, toppings, and degree of doneness for a filet mignon). And each modifier group may comprise numerous modifiers (e.g., rare, medium rare, medium, medium well, and well done in the degree of doneness modifier group. Consequently, a typical restaurant menu structure is a hierarchical relationship between menu tiers such as, but not limited to, menu groups, menu subgroups, menu items, modifier groups, and modifiers and presentation of those tiers to a server taking orders from a guest or to the guests themselves via interactive displays on the mobile POS terminals 121 and fixed POS terminals 123 is becomes challenging when speed and heuristics are driving factors.

Many restaurants and restaurant chains meet the above challenges by designing and deploying custom menu display and ordering solutions that provide for display of mixed tiers such as placing most ordered menu items from most ordered menu groups on a single display screen such as placing four menu items from each menu subgroup on the single screen. Though such an optimization may be sufficient for a given restaurant or restaurant chain, it is not scalable nor sufficient to apply to multiple restaurants and restaurant chains, such as the over 30,000 restaurants contemplated by the system 100 of FIG. 1. This is because virtually every restaurant menu is different in ways that the above optimization would require custom solutions for each different restaurant in the system 100.

In addition to the above-note wide divergence of menus, another factor considered by the present inventors in providing for more accurate and efficient menu display and ordering techniques is that guests don't always order according to menu hierarchy, namely specifying a menu group first, menu subgroup second, menu item third, etc. That is, a guest may place and order in a dynamic conversational manner, beginning with a several modifiers before actually specifying a menu item. For instance, one guest may order a “coffee, dark roast, large, with two sugars and an extra splash of cream.” Another guest at the same restaurant may order a “vegan cheese pizza, no onions, extra sauce, 12-inch.”

Unless customized, a typical POS display in a restaurant may display menu groups. When one menu group is selected, its menu subgroups may be displayed to the side or below. When a particular subgroup is selected, another screen may be displayed to the guest/server that shows the menu items for that menu subgroup. When a menu item is selected, the guest/server may be presented with another screen that displays modifier groups and corresponding modifiers. Once all selections for a menu item are selected, then the guest/server is returned to the main screen that displays the menu groups to begin the process for the next menu item. Accordingly, the present inventors have observed that present-day digital menu displays are constrained display only that content which can be displayed on a single screen page, thus presenting only a limited number of selectable items to a guest/server.

Therefore, it is an object of the present invention to provide techniques and mechanisms the enable unconstrainted display content for digital menu displays that in addition facilitate rapid and efficient entry of orders by a server and/or guest. It is additionally an object of the present invention to provide methods and system for display of hierarchical digital menus that can easily be adapted to a multitude of different restaurant fares and that is scalable for individual and chain restaurant menus. It is furthermore an object of the present invention to provide a conversational menuing method and system that dynamically changes to support conversational ordering styles and that supports changes in orders. It is moreover an object of the present invention to provide a digital menu display mechanism that presents a complete virtual set of modifiers for a menu item that can be scrolled by a server/guest. It is yet another object of the present invention to provide a digital menu display that adapts the display of both upper and lower hierarchical menuing levels when a given group, subgroup, menu item, modifier group, or modifier is selected. The present invention also provides for identification of tiers that cannot be ordered due to inventory and or class restrictions (e.g., no beef entries displayed for “vegan” modifier group). It is finally an object of the present invention to provide a conservational menu display and ordering method and system that employs one or more processors to analyze historical orders for a restaurant or restaurant chain and that dynamically rearranges and/or preselects class icons on a menu display to place and preselect class icons for those most ordered tiers in prominent positions to enable rapid ordering by a server and/or guest. Although this disclosure employs a restaurant scenario for application of this novel menu display and ordering technique, such is presented only to teach those essential elements of the present invention to those skilled in the art. The present inventors note, however, that the techniques disclosed herein can be easily adapted to any hierarchical retail item display and ordering system and should not be constrained to the restaurant industry.

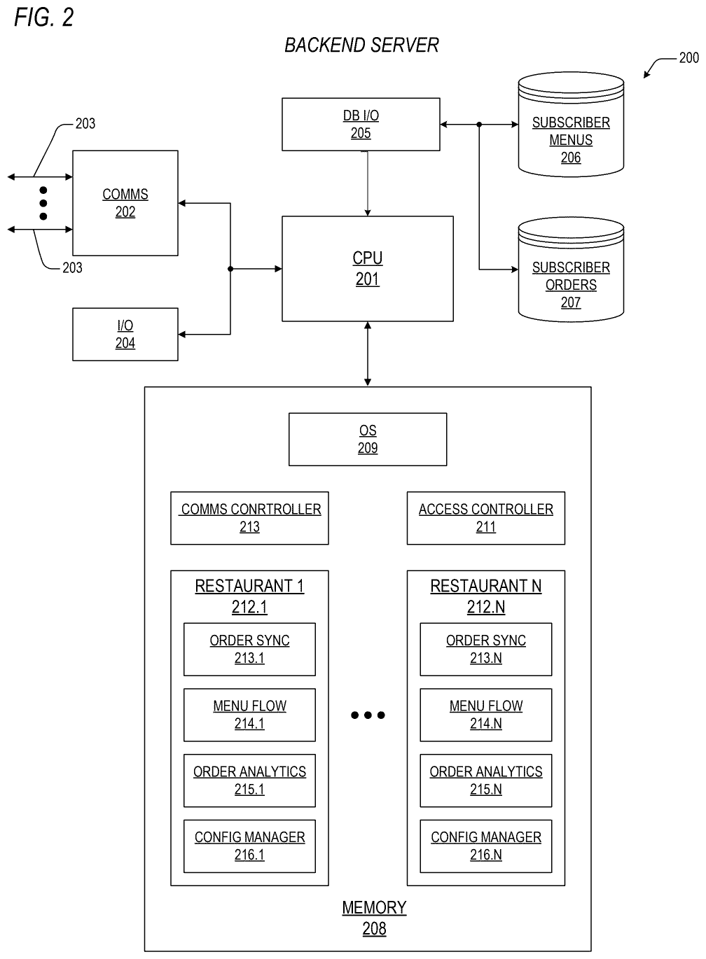

Referring to FIG. 2, a block diagram is presented depicting a backend server 200, such as may be employed within the system 100 of FIG. 1. In various embodiments, the backend server 200 may comprise a central processing unit (CPU) 201 that is coupled to a memory 208 having both transitory and non-transitory memory components therein. The CPU 201 is also coupled to a communications circuit 202 that couples the backend server 200 to the internet 110 via one or more wired and/or wireless links 203 as are discussed above. The backend server 200 may also comprise input/output circuits 204 that include, but are not limited to, data entry and display devices (e.g., keyboards, monitors, touchpads, etc.), where the input/output circuits 204 are coupled to the communications circuit 202 and the CPU 201. The CPU 201 is also coupled to database input/output circuits 205. The database input/output circuits 205 are coupled to a subscriber menus database 206 and a subscriber orders database 207. In one embodiment, the subscriber menus database 206 and subscriber orders database 207 are disposed in the same location as the backend server 200. In another embodiment, the subscriber menus database 206 and subscriber orders database 207 are not disposed in the same location as the server 200 and are accessed via messages transmitted and received over the links 203 rather than by direct connection as shown in the diagram.

The memory 208 may include an operating system 209 such as, but not limited to, Microsoft Windows, Mac OS, Unix, and Linux, where the operating system 209 is configured to manage execution by the CPU 201 of program instructions that are components of one or more application programs. In one embodiment, a single application program comprises a plurality of modules (or “code segments”) 211, 213, 212.1-212.N, 213.1-213.N, 214.1-214.N, 215.1-215.N, 216.1-216.N resident in the memory 208 and identified as a communications controller segment (COMMS CONTROLLER) 213, a database access controller segment (ACCESS CONTROLLER) 211 and a plurality of restaurant segments 212.1-212.N, each corresponding to one of the subscriber restaurants 120. Each of the plurality of restaurant segments 212.1-212.N includes a corresponding order synchronization segment (ORDER SYNC) 213.1-213.N, a menu display flow segment (MENU FLOW) 214.1-214.N, an order analytics segment (ORDER ANALYTICS) 215.1-215.N, and a configuration manager segment (CONFIG MANAGER) 216.1-216.N

Operationally, the backend server 200 may execute one or more of the code segments 211, 213, 212.1-212.N, 213.1-213.N, 214.1-214.N, 215.1-215.N, 216.1-216.N as required perform the functions disclosed above with reference to FIG. 1 to provide for menu display configured for conversational ordering, order entry, order fulfillment, payment, analytics of historical orders, dynamic modification and update of subscriber digital menus within the subscriber menus database 206 when those menus are changed and when analytics provided by the order analytics segment 215.1-215.N indicate a priority of tiers ranging from most ordered to least orders, and update of records within the subscriber order database 207 to store historical order data and metadata as is disclosed above for purposes of determining how to rearrange menu class icons on corresponding virtual menu displays based upon most-ordered item priority. ACCESS CONTROLLER 211 may execute anytime access is required by other segments to the subscriber menus database 206 or the subscriber orders database 207 to create new records in the databases 206-207, to read records stored in the databases 206-207, and to update existing records stored in the databases 206-207.

All of the like named segments within each of the restaurant segments 212.1-212.N operate is substantially the same manner to communicate with and control terminals 121, 123, 124 within each of the subscriber restaurants. The restaurant segments 212.1-212.N may be configured differently to accommodate different numbers and configurations of terminals 121, 123, 124, different menus, different kitchen conditions, different locations and external influencing factors, and different options for predicting order preparation times. Though configured differently, the restaurant segments 212.1-212.N are configured to perform the same functions for each of their corresponding restaurants and, thus, it is sufficient to describe operation of a single restaurant segment 212.1. ORDER SYNC 213.1 may execute to receive new orders from restaurant 1 120 that are entered via one or more corresponding terminals 121, 123, to direct one or more kitchen fulfillment terminals 124 therein to perform sequencing and coursing of the new orders, to synchronize states and status of all orders in restaurant 1 with all terminals 121, 123, 124 therein, to accept and process payment for the new orders, to close out orders when payment is received/authorized, to receive all order data and metadata corresponding to the completed orders from the kitchen fulfillment terminals 124, and to direct the database I/O circuit 205 to update records for restaurant 1 in the subscriber order database 207 with the received order data, kitchen fulfillment metadata, and other order metadata to provide a ground truth set of data that may be subsequently employed for determination of a prioritization of menu tiers that identifies most ordered tiers, which may be employed by MENU FLOW 214.1 as described below. ORDER SYNC segments 213.2-213.N operate in substantially the same manner for restaurants 2-N as segment 213.1 operates for restaurant 1

MENU FLOW 214.1 may be executed to generate a digital conversational menu corresponding to restaurant 1, according to a menu hierarchy for the restaurant that may comprise a plurality of tiers. In one embodiment, the tiers comprise menu group, menu subgroup, menu item, modifier group, and modifiers. Another embodiment contemplates additional tiers, and a further embodiment envisions a subset of the above-noted tiers. As a default, MENU FLOW 214.1 may generate a menu for restaurant 1 that displays icons on a digital touch screen display of one or more corresponding terminals 121, 123 in restaurant 1, where the display order (i.e., left-to-right and top-to-bottom) of the icons is the same as the order in which elements of each of the menu tiers is entered by restaurant staff via the COMMS 202 or the I/O 204 interfaces. Once entered, instructions for configuration of the default digital menu are provided by MENU FLOW 214.1 via COMMS 202 to the one or more corresponding terminals 121, 123 in restaurant 1. MENU FLOW 214.1 may additionally communicate with the subscriber orders database 207, CONFIG MANAGER 216.1, and the one or more corresponding terminals 121, 123 in restaurant 1 to determine current inventory of elements within each menu tier. When one or more elements within a given menu tier are no longer in inventory, MENU FLOW 214.1 may transmit messages via COMMS 202 to the one or more corresponding terminals 121, 123 in restaurant 1 that change the configuration of the default digital menu such that icon(s) for the exhausted element(s) are display in a manner that contrasts with selectable elements and that additionally precludes the exhausted elements from being selected by staff and/or guests. MENU FLOW 214.1 may further receive a menu tier prioritization from ORDER ANALYTICS 215.1 that ranks elements of the menu tiers from most ordered to least ordered. Responsively, MENU FLOW 214.1 may generate a modified menu for restaurant 1 that displays icons on a digital touch screen display of one or more corresponding terminals 121, 123 in restaurant 1, where the display order of the icons corresponds to the ranking of the elements as provided by ORDER ANALYTICS 215.1 and that further preselects one or more of the most ordered elements within one or more of the menu tiers. Once entered, instructions for configuration of the modified digital menu are provided by MENU FLOW 214.1 via COMMS 202 to the one or more corresponding terminals 121, 123 in restaurant 1. MENU FLOW segments 214.2-214.N operate in substantially the same manner for restaurants 2-N as segment 214.1 operates for restaurant 1.

ORDER ANALYTICS 215.1 periodically accesses the subscriber orders database 207 and analyzes historical orders to determine a ranking of tier elements for restaurant 1 from most ordered to least ordered. In one embodiment, only historical orders fulfilled by restaurant 1 are employed in this determination. In another embodiment, historical orders from all restaurants in a chain of restaurants comprising restaurant 1 are employed in the determination. Other embodiments may employ chain restaurants withing a geographic boundary (e.g., city, metro area, state, etc.) for the determination. In one embodiment, the determination is performed once every day. Other embodiments are contemplated as well including, but not limited to, weekly, monthly, and quarterly. The ranking of tier elements for restaurant 1 is then transmitted to MENU FLOW.214.1 to provide a basis for rearrangement of tier element icons on its corresponding digital menu. ORDER ANALYTICS segments 215.2-215.N operate in substantially the same manner for restaurants 2-N as segment 215.1 operates for restaurant 1.

The backend server 101, 200 according to the present invention is configured to perform the functions and operations as discussed above. The backend server 101, 200 may comprise digital and/or analog logic, circuits, devices, or microcode (i.e., micro instructions or native instructions), or a combination of logic, circuits, devices, or microcode, or equivalent elements that are employed to execute the functions and operations according to the present invention as noted. The elements employed to accomplish these operations and functions within the backend server 101, 200 may be shared with other circuits, microcode, etc., that are employed to perform other functions and/or operations within the backend server 101, 200. According to the scope of the present application, microcode is a term employed to refer to one or more micro instructions. A micro instruction (also referred to as a native instruction) is an instruction at the level that a unit executes.

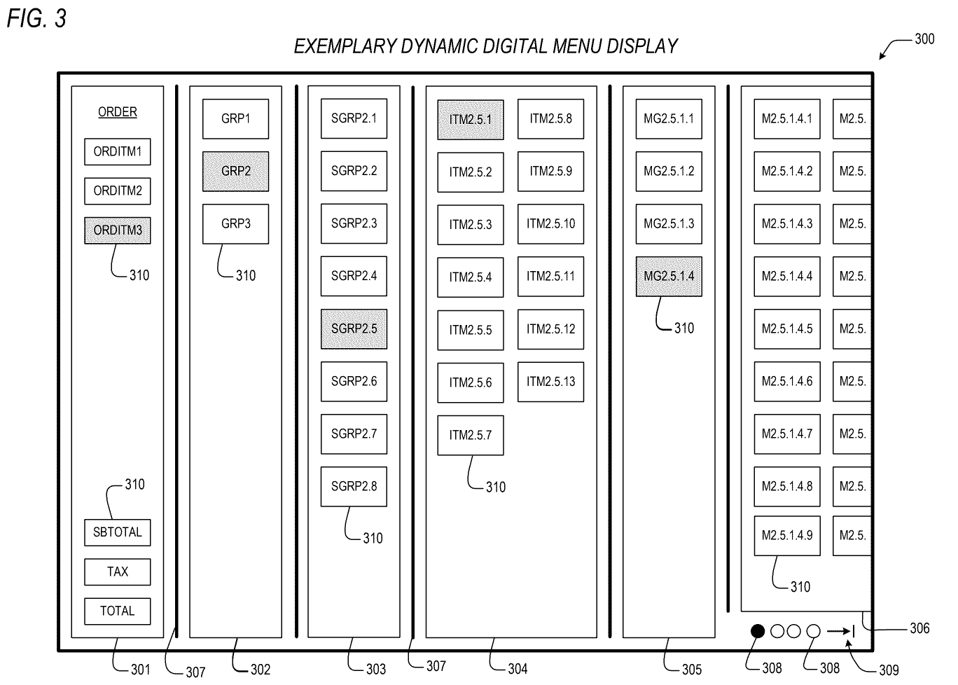

Turning now to FIG. 3, a diagram is presented featuring an exemplary dynamic digital menu display 300 according to the present invention, such as may be embodied as a touchscreen display on one or more of the mobile terminals 121 or fixed terminals 123 within a restaurant 120 employing the dynamic conversational menu display and ordering system 100 of FIG. 1. The display 300, in the exemplary embodiment, may comprise a digital virtual menu for a restaurant that is presented in a landscape mode, where the digital virtual menu is divided into a series of columns 301-306 demarcated by dividing bars 307. The digital virtual menu may comprise a series of display screens 300 that may be scrolled via swiping or via touching a swipe icon 309. A plurality of display screen markers 308 are displayed as well to inform a server/guest which display screen 300 is current relative to the remaining display screens 300 within the digital virtual menu. As is shown in the diagram a leftmost display screen marker 308 is shown in a contrasting color to indicate that the server/guest is viewing the leftmost display screen within the virtual menu.

A current order column 301 may comprise a plurality of icons 310 that reflect a current order being taken by a server or being entered by a guest. Icons ORDITM1-ORDITM3 may indicate ordered items and their corresponding modifications currently on order. In one embodiment, ORDITM1-ORDITM3 may be selected by a server/guest and will be shown in a contrasting highlight when selected. As each additional item is ordered a corresponding new ordered item icon 310 ORDITMX is generated by the terminal 121, 123 for display in the current order column 301. The current order column 301 may further comprise icons 310 that indicate metadata for the entire order such as, but not limited to, subtotal cost (SBTOTAL), tax owed (TAX), and total amount due (TOTAL).

To the right of the current order column 301 is a menu group column 302 comprising element icons 310 for each member of the restaurant's menu groups. The exemplary display 300 shows 3 icons GRP1-GRP3, one of which may be selected to add to a current order item (i.e., ORDITM3). When selected, an icon GRP1-GRP3 may be shown in a contrasting highlight. The menu group icon GRP1-GRP3 may be selected to enable ordering of a menu item along with modifications from the selected menu group. If an order item icon ORDITM1-ORDITM3 has been selected, then a menu group icon GRP1-GRP3 that corresponds to the selected order item icon ORDITM1-ORDITM3 will be highlighted.

To the right of the menu group column 302 is a menu subgroup column 303 comprising element icons 310 for each member of the restaurant's menu subgroups. The exemplary display 300 shows 8 icons SGRP2.1-SGRP2.8, one of which may be selected. When selected, an icon SGRP2.1-SGRP2.8 may be shown in a contrasting highlight. A menu group icon SGRP2.1-SGRP2.8 may be selected to enable ordering of a menu item along with modifications from the selected menu subgroup. If a menu group icon GRP1-GRP3 has been selected, then menu subgroup icons icon SGRP2.1-SGRP2.8 are displayed that correspond to the selected menu group GRP1-GRP3. If an order item icon ORDITM1-ORDITM3 has been selected, then a menu group icon GRP1-GRP3 that corresponds to the selected order item icon ORDITM1-ORDITM3 will be highlighted and its menu subgroup icon SGRP2.1-SGRP2.8 will be highlighted. As the display 300 shows, ORDITM3 is selected, which highlights menu group GRP2 and menu subgroup SGRP2.5.

To the right of the menu subgroup column 303 is a menu item column 304 comprising element icons 310 for each member of the restaurant's menu items within a selected menu group and menu subgroup. The exemplary display 300 shows 13 icons ITM2.5.1-ITM2.5.13, one of which may be selected. When selected, an icon ITM2.5.1-ITM2.5.13 may be shown in a contrasting highlight. A menu item icon ITM2.5.1-ITM2.5.13 may be selected to enable ordering of a menu item that corresponds to the selected menu item icon ITM2.5.1-ITM2.5.13. If a menu subgroup icon SGRP2.1-SGRP2.8 has been selected, then menu item icons ITM2.5.1-ITM2.5.13 are displayed that correspond to the selected menu subgroup SGRP2.1-SGRP2.8. If an order item icon ORDITM1-ORDITM3 has been selected, then a menu group icon GRP1-GRP3 that corresponds to the selected order item icon ORDITM1-ORDITM3 will be highlighted, its menu subgroup icon SGRP2.1-SGRP2.8 will be highlighted, and its corresponding menu item ITM2.5.1-ITM2.5.13. As the display 300 shows, ORDITM3 is selected, which highlights menu group GRP2, menu subgroup SGRP2.5, and menu item ITM2.5.1.

To the right of the menu item column 304 is a modifier group column 305 comprising element icons MG2.5.1.1-MG2.5.1.4 for each member of the restaurant's modifier group that corresponds to a selected menu item icon ITM2.5.1-ITM2.5.13 in menu item column 304. The exemplary display 300 shows 4 modifier group icons MG2.5.1.1-MG2.5.1.4, one of which may be selected. When selected, a modifier group icon ITM2.5.1-ITM2.5.13 may be shown in a contrasting highlight. A modifier group item icon MG2.5.1.1-MG2.5.1.4 may be selected to show modifiers M2.5.1.4.1-M2.5.1.4.X for a menu item corresponding to the selected modifier group icon MG2.5.1.1-MG2.5.1.4. If a menu item ITM2.5.1-ITM2.5.13 has been selected, then modifier group icons MG2.5.1.1-MG2.5.1.4 are displayed that correspond to the selected menu item ITM2.5.1-ITM2.5.13. If an order item icon ORDITM1-ORDITM3 has been selected, then a menu group icon GRP1-GRP3 that corresponds to the selected order item icon ORDITM1-ORDITM3 will be highlighted, its menu subgroup icon SGRP2.1-SGRP2.8 will be highlighted, its corresponding menu item ITM2.5.1-ITM2.5.13 will be highlighted, and one or more of its modifier group icons MG2.5.1.1-2.5.1.4 will be highlighted. As the display 300 shows, ORDITM3 is selected, which highlights menu group GRP2, menu subgroup SGRP2.5, menu item ITM2.5.1, and modifier group MG2.5.1.4.

Finally, to the right of the modifier group column 305 is a modifier column 306 comprising element icons M2.5.1.4.1-M2.5.1.4.X for each member of the restaurant's modifiers that correspond to a selected modifier group icon MG2.5.1.1-MG2.5.1.413 in modifier group column 305. The exemplary display 300 shows N modifiers icons M2.5.1.4.1-M2.5.1.4.N, one or more of which may be selected. When selected, a modifier icon M2.5.1.4.1-M2.5.1.4.N may be shown in a contrasting highlight. A modifier group item icon M2.5.1.4.1-M2.5.1.4.X may be selected to modify a menu item in accordance with the selected modifier group icon MG2.5.1.1-MG2.5.1.4. If a menu item ITM2.5.1-ITM2.5.13 has been selected, then modifier group icons MG2.5.1.1-MG2.5.1.4 are displayed that correspond to the selected menu item ITM2.5.1-ITM2.5.13. If an order item icon ORDITM1-ORDITM3 has been selected, then a menu group icon GRP1-GRP3 that corresponds to the selected order item icon ORDITM1-ORDITM3 will be highlighted, its menu subgroup icon SGRP2.1-SGRP2.8 will be highlighted, its corresponding menu item ITM2.5.1-ITM2.5.13 will be highlighted, one or more of its modifier group icons MG2.5.1.1-2.5.1.4 will be highlighted, and one or more of its modifiers will be highlighted, where the modifiers, in one embodiment, correspond to an upper highlighted modifier group icon MG2.5.1.1-2.5.1.4. As the display 300 shows, ORDITM3 is selected, which highlights menu group GRP2, menu subgroup SGRP2.5, menu item ITM2.5.1, modifier group MG2.5.1.4.

The digital menu display 300 is shown comprising menuing elements 310 that are numbered to reflect the hierarchical nature of an exemplary menu according to the present invention. For instance, modifier icons M2.5.1.4.1-M2.5.1.4.X all belong to selected modifier group MG 2.5.1.4. Modifier group icons MG2.5.1.1-MG2.5.1.4 all belong to menu item selected menu item ITM2.5.1. Menu item icons ITM2.5.1-ITM2.5.13 all belong to selected menu subgroup SGRP2.5. Menu subgroup icons SGRP2.1-SGRP2.8 all belong to selected menu group GRP2. And the exemplary hierarchical menu show comprises three menu groups GRP1-GRP3.

As is noted above the system 100 according to the present invention contemplates additional menu hierarchy tiers over those disclosed with reference to FIG. 3. For example, a particular restaurant's menu hierarchy may include, say, menu subgroup ingredients tier that is between the menu subgroups tier and the menu item tier where the menu subgroup ingredients tier many comprise elements related to ingredients employed in the menu items of a given menu subgroup such as “gluten free,” “vegetarian,” “vegan,” “allergen free,” etc. Advantageously, the present invention is adapts its digital virtual menu 300 displayed based on the hierarchical menu structure entered as a default structure. Accordingly, the display 300 would include an addition menu tier column (not shown) for the menu subgroup ingredients tier between the menu subgroup column 303 and menu item column 304, where the elements in the menu subgroup ingredients tier are displayed as icons 310 and are selectable.

Similarly, the system 100 according to the present invention contemplates menu hierarchy tiers that are a subset of those disclosed with reference to FIG. 3. For example, a particular restaurant's menu hierarchy may only comprise a single menu group, in which case the virtual menu page 300 would not display the menu groups column 302 and the menu subgroups column 303 and would instead display the menu items column 304 immediately adjacent to the order column 301.

The present inventors note that elements in the modifier menu tier may belong to both elements in the menu item tier and also to elements in the menu subgroup tier. Accordingly, one embodiment of the present invention precludes display of the modifier group column 305 and modifiers column 306 until a menu item 310 is selected from the menu item column 304.

In a similar embodiment, when a menu item icon 310 is selected from within its menu item column 304, rather than displaying a modifier group column 305 and a single modifier column 306 showing modifiers for a selected modifier group element 310 (e.g., MG2.5.1.4), the display 300 would show multiple modifier columns 306 corresponding to the selected menu item 310, where each of the modifier columns 306 may comprise modifier element within a corresponding modifier group MG2.5.1.1-MG2.5.1.4. In the example of FIG. 3, four modifier columns 306 would be shown for selected menu item ITM2.5.1, where the modifier columns 306 would show modifier elements for modifier group MG2.5.1.1, followed by those of modifier group MG2.5.1.2, followed by those of modifier group MG2.5.1.3, followed by those of modifier group MG2.5.1.4. The digital menu display 300 of FIG. 3 is shown in a landscape mode with the virtual menu scrolling from left to right; however, the present inventors note that other embodiments are contemplated as well including, but not limited to, landscape scrolling right to left, portrait mode scrolling left to right, and portrait mode scrolling right to left. The display 300 may further be embodied as a series of rows as opposed to columns with row dividers for the different menu tiers that may be configured in landscape or portrait mode, scrolling down or up.

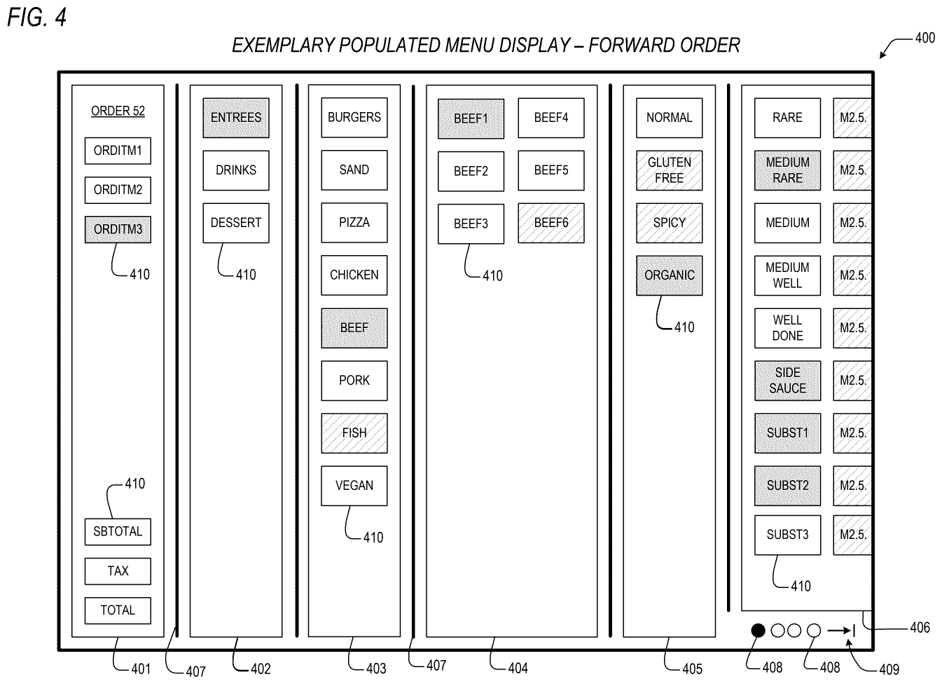

Referring now to FIG. 4, a diagram is presented showing an exemplary populated menu display 400 according to the present invention as may be applied to a guest's forward conversational ordering manner for selection either by the guest or a server waiting on the guest. The menu display 400 is substantially similar to the menu display 300 of FIG. 3, where like-numbered elements operate essentially the same as those in FIG. 3, where the hundreds digit is replaced by a “4.” This display 400 is provided to show how an exemplary restaurant may populate it hierarchical menu within the dynamic conversational menu display and ordering system 100 of FIG. 1 and how a server/guest may employ a forward conversational manner to enter an order item.

A current order column 401 may comprise a plurality of icons 410 that reflect a current order being taken by a server or being entered by a guest. Icons ORDITM1-ORDITM3 may indicate ordered items and their corresponding modifications currently on order. In one embodiment, ORDITM1-ORDITM3 may be selected by a server/guest and will be shown in a contrasting highlight when selected. As each additional item is ordered a corresponding new ordered item icon 410 ORDITMX is generated by the terminal 121, 123 for display in the current order column 401. The current order column 401 may further comprise icons 410 that indicate metadata for the entire order such as, but not limited to, subtotal cost (SBTOTAL), tax owed (TAX), and total amount due (TOTAL). As is shown, the display 400 shows ORRITM3 selected.

To the right of the current order column 401 is a menu group column 402 comprising element icons 410 for each member of the restaurant's menu groups ENTREES, DRINKS, DESSERT. As is shown, the ENTREES menu group icon 410 is highlighted indicating that order item ORDITM3 is an ENTRE.

To the right of the menu group column 402 is a menu subgroup column 403 comprising element icons 410 for each member of the restaurant's menu subgroups BURGERS, SAND, PIZZA, CHICKEN, BEEF, PORK, FISH, VEGAN. As is shown, the BEEF menu subgroup icon 410 is highlighted indicating that order item ORDITM3 is an entrée from group ENTRE, and the entrée is from the BEEF subgroup. The present inventors note also that the FISH menu subgroup icon 410 is displayed in a manner that contrasts with selectable subgroup elements and that additionally precludes the FISH menu subgroup from being selected by staff and/or guests, perhaps due to inventory depletion or other factors communicated to the POS terminals 121, 123 by the backend server 101, 200.

To the right of the menu subgroup column 403 is a menu item column 404 comprising element icons 410 for each member of the restaurant's menu items BEEF1-BEEF6 within the BEEF menu subgroup. As is shown, the BEEF1 menu item icon 410 is highlighted indicating that order item ORDITM3 is an entrée from group ENTRE, the entrée is from the BEEF menu subgroup, and the entrée is BEEF1. The present inventors note also that the BEEF6 menu item icon 410 is displayed in a manner that contrasts with selectable subgroup elements and that additionally precludes the BEEF6 menu item from being selected by staff and/or guests, perhaps due to inventory depletion or other factors communicated to the POS terminals 121, 123 by the backend server 101, 200.

To the right of the menu item column 404 is a modifier group column 405 comprising element icons 410 for each member of the restaurant's modifier groups NORMAL, GLUTEN FREE, SPICY, ORGANIC that may be applied to modify the BEEF1 menu item. As is shown, the ORGANIC modifier group icon 410 is highlighted indicating that order item ORDITM3 is an entrée from group ENTRE, the entrée is from the BEEF menu subgroup, the entrée is BEEF1, and ORGANIC has been selected to present modifiers for the entrée that are in the organic modifier group. The present inventors note also that the GLUTEN FREE and SPICY modifier group icons 410 is displayed in a manner that contrasts with selectable subgroup elements and that additionally precludes GLUTEN FREE and SPICY modifier groups from being selected by staff and/or guests, perhaps due to inventory depletion or other factors communicated to the POS terminals 121, 123 by the backend server 101, 200.

To the right of the modifier group column 405 is a modifier column 406 comprising element icons 410 for each member of the restaurant's modifiers RARE, MEDIUM RARE, MEDIUM, MEDIUM WELL, WELL DONE, SIDE SAUCE, SUBST1, SUBST2, SUBST3, and other modifiers beginning with M2.5 . . . which can be viewed and selected by scrolling the virtual display via swipe or swipe control 409. As is shown, the MEDIUM RARE, SIDE SAUCE, STUBST1 and SUBST2 modifier icons 410 are highlighted indicating that order item ORDITM3 is an entrée from group ENTRE, the entrée is from the BEEF menu subgroup, the entrée is BEEF1, and modifiers MEDIUM RARE, SIDE SAUCE, STUBST1 and SUBST2 have been selected from the ORGANIC modifier group. The present inventors note also that the modifiers beginning with modifiers beginning with M2.5 modifier icons 410 are displayed in a manner that contrasts with selectable subgroup elements and that additionally precludes the shown M2.5 modifiers from being selected by staff and/or guests, perhaps due to inventory depletion or other factors communicated to the POS terminals 121, 123 by the backend server 101, 200.

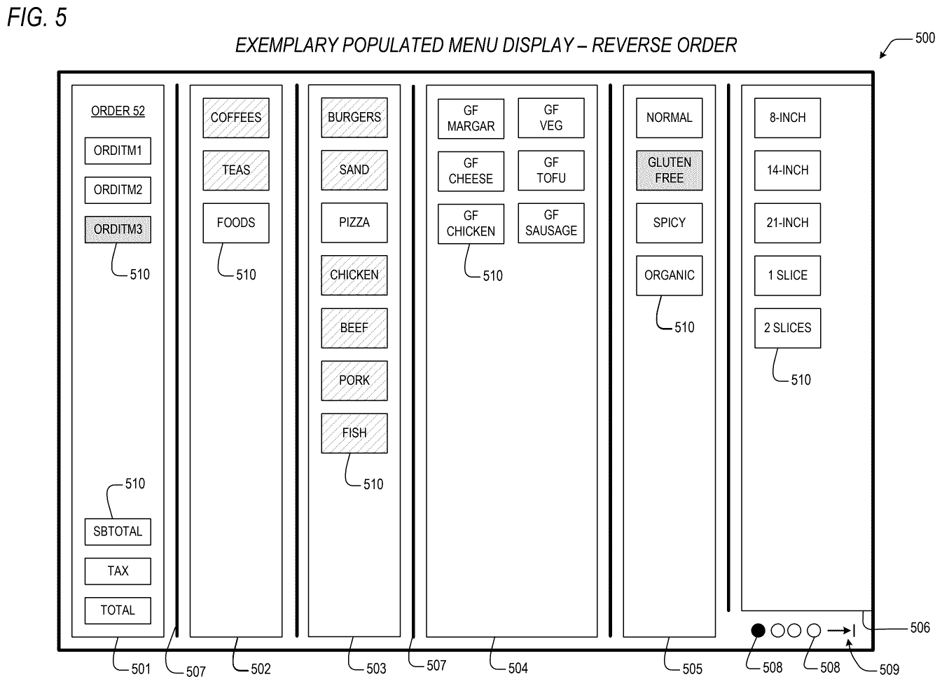

Now turning to FIG. 5, a diagram is presented showing an exemplary populated menu display 500 according to the present invention as may be applied to a guest's reverse conversational ordering manner for selection either by the guest or a server waiting on the guest. The menu display 500 is substantially similar to the menu display 300 of FIG. 3, where like-numbered elements operate essentially the same as those in FIG. 3, where the hundreds digit is replaced by a “5.” This display 500 is provided to show how an exemplary restaurant may populate it hierarchical menu within the dynamic conversational menu display and ordering system 100 of FIG. 1 and how a server/guest may employ a forward conversational manner to enter an order item.

A current order column 501 may comprise a plurality of icons 510 that reflect a current order being taken by a server or being entered by a guest. Icons ORDITM1-ORDITM3 may indicate ordered items and their corresponding modifications currently on order. In one embodiment, ORDITM1-ORDITM3 may be selected by a server/guest and will be shown in a contrasting highlight when selected. As each additional item is ordered a corresponding new ordered item icon 510 ORDITMX is generated by the terminal 121, 123 for display in the current order column 501. The current order column 501 may further comprise icons 510 that indicate metadata for the entire order such as, but not limited to, subtotal cost (SBTOTAL), tax owed (TAX), and total amount due (TOTAL). As is shown, the display 500 shows ORRITM3 selected.

Columns for menu groups 502, menu subgroups, 503, menu items 504, modifier groups 505, and modifiers 506 are configured from left to right in descending order according to the restaurant's hierarchical menu structure. In this example, a server/guest, rather than specifying ORDITM3 in hierarchical order, the server/guest has first selected modifier group GLUTEN FREE which, as one skilled in the art will appreciate, is often the case when a guest places and order. In this case, gluten free is top of mind to the guest and outranks other options. Advantageously, the present invention allows for this type of conversational ordering style. The GLUTEN FREE modifier group icon 510 is shown highlighted and selected and because of restaurant menu or inventory restrictions, the only entrée group that is enabled for selection is FOODS and within that group, the only menu subgroup that is enabled for selection is PIZZA. Selectable menu items withing the PIZZA subgroup comprise GF MARGAR, GF CHEESE, GF CHICKEN, GF VEG, GF TOFU, and GF SAUSAGE pizzas. And for any of the shown menu items, portion size modifiers are enabled for selection that include 8-INCH, 14-INCH, 21-INCH, 1 SLICE, and 2 SLICES. If the guest/server had selected, say, the SPICY modifier group, an entirely different listing in the columns 502-506 would be displayed that comport with groups, subgroups, menu items, and modifiers comprising SPICY modifiers.

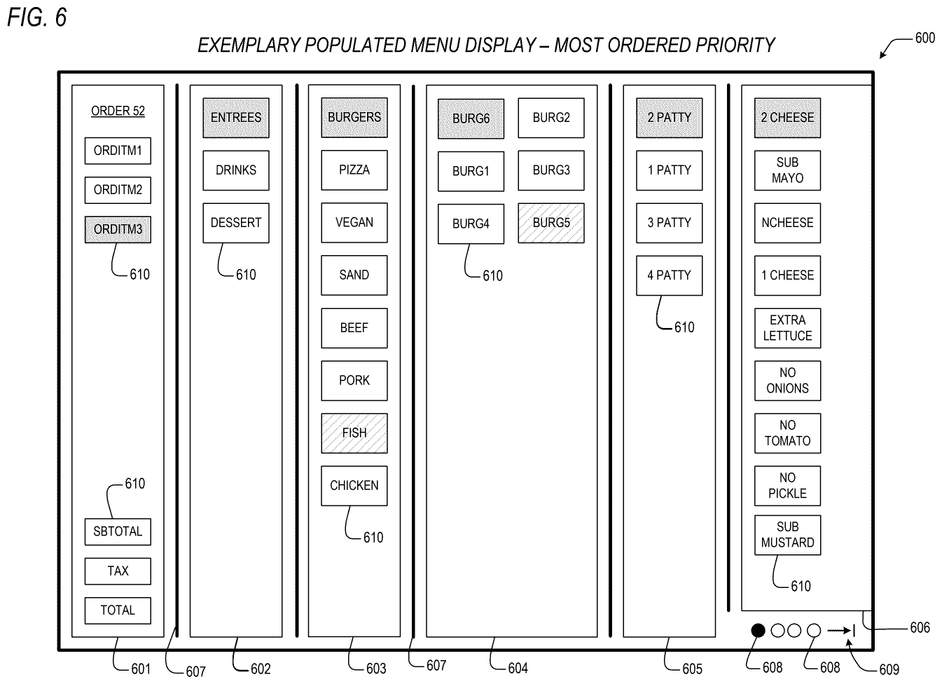

Now referring to FIG. 6, is a diagram is presented showing an exemplary populated menu display 600 according to the present invention as modified via a processor's analysis of items most ordered from one or more corresponding restaurant menus. As is disclosed above with reference to FIGS. 1-2, as orders are fulfilled by a restaurant, they are communicated the backend server 200. The backend server 200 updates the subscriber order database 207 with the fulfilled order data, kitchen fulfillment metadata, and other order metadata to provide a ground truth set of data that may be subsequently employed for determination of a prioritization of menu tiers that identifies most ordered tiers. Accordingly, one or more ORDER ANALYTICS modules 215.1-215.N that correspond to the restaurant's menu are executed by the processor 201 in the backend server to determine and identify elements of its menu tiers that have been most ordered by guests since the last time subscriber orders for the restaurant have been analyzed; that is, ORDER ANALYTICS 215.1-215.N analyzes historical orders to determine a ranking of menu tier from most ordered to least ordered elements for the restaurant. In one embodiment, only historical orders fulfilled by the restaurant are employed in this determination. In another embodiment, historical orders from all restaurants in a chain of restaurants comprising the restaurant are employed in the determination. Other embodiments may employ chain restaurants comprising the restaurant withing a geographic boundary (e.g., city, metro area, state, etc.) for the determination. In one embodiment, the determination is performed once every day. Other embodiments are contemplated as well including, but not limited to, weekly, monthly, and quarterly.

The ranking of tier elements for restaurant 1 is then transmitted to a corresponding MENU FLOW module 214.1-214.N to provide a basis for rearrangement of menu element icons on the restaurant's corresponding digital menu. MENU FLOW 214.1-214.N operates to employ the ranking provided by ORDER ANALYTICS 215.1-215.N to generate an optimized virtual digital menu for the restaurant that places most ordered element icons in most accessible positions on the display menu. MENU FLOW 214.1-214.N then transmits this modified and optimized virtual digital menu layout to the POS terminals 121, 123 in the restaurant for display and ordering.

Like the menus of FIGS. 3-5, the menu display 600 of FIG. 6 has a current order column 601 may comprise a plurality of icons 610 that reflect a current order being taken by a server or being entered by a guest. Icons ORDITM1-ORDITM3 may indicate ordered items and their corresponding modifications currently on order. In one embodiment, ORDITM1-ORDITM3 may be selected by a server/guest and will be shown in a contrasting highlight when selected. As each additional item is ordered a corresponding new ordered item icon 610 ORDITMX is generated by the terminal 121, 123 for display in the current order column 601. The current order column 601 may further comprise icons 610 that indicate metadata for the entire order such as, but not limited to, subtotal cost (SBTOTAL), tax owed (TAX), and total amount due (TOTAL). As is shown, the display 600 shows ORRITM3 selected.

Columns for menu groups 602, menu subgroups, 603, menu items 604, modifier groups 605, and modifiers 606 are configured from left to right in descending hierarchical order according to the restaurant's hierarchical menu structure. In this example, in contrast to the examples of FIGS. 3-5, the icons 610 for each menu tier are reordered in their respective tier column 602-606 to optimally place most ordered item icons 610 in positions optimally selectable by a server/guest. In this example, the most ordered item icons 610 are placed in top positions in their respective columns and they are shown pre-selected via a contrasting color. More specifically, the most recent execution of ORDER ANALYTICS 215.1-215.N for the restaurant ranked a double-patty (“2 PATTY”), double-cheese (“2 CHEESE” burger (BURG6), an entrée (“ENTREES”) from the burger submenu (“BURGERS”) as the most ordered item (including modifiers) and corresponding tier element icons have been rearranged by MENU FLOW 214.1-214.N as shown to reflect the recent ranking determination. Advantageously, restaurant ordering efficiency is significantly improved according to the present invention so that a server/guest can quickly place an order using the modified menu.

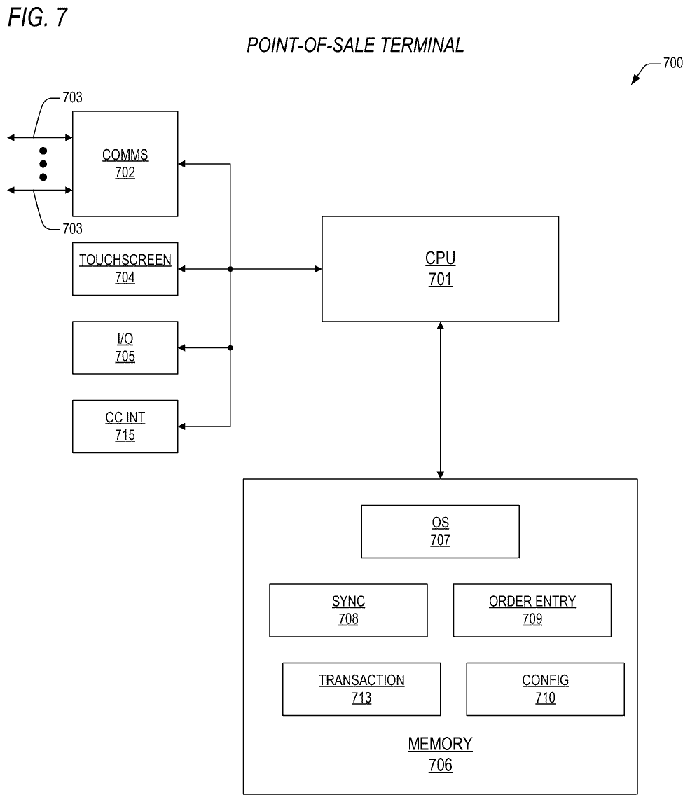

Turning to FIG. 7, a block diagram is presented showing a point-of-sale terminal 700 according to the present invention, such as may be employed in the system 100 of FIG. 1. The terminal 700 may be embodied as either a fixed terminal 123 or a mobile terminal 121 as is discussed above with reference to FIG. 1, the differences being generally size of the terminal 700, power requirements (battery or hard wired), and connection (wired or wireless) to the gateway 125. Generally, a fixed terminal 123 is larger in size than a mobile terminal 121 and the mobile terminal 121 is sized so that it can be easily carried by a server in the restaurant.

The terminal 700 may be embodied as a central processing unit (CPU) 701 that is coupled to a memory 706 having both transitory and non-transitory memory components therein. The CPU 701 is also coupled to a communications circuit 702 that couples the terminal 700 to a gateway 125 within the establishment via one or more wired and/or wireless links 703 as are discussed above. Through these links 703, the terminal 700 along with other terminals 121, 123 in the establishment may directly communicate with the backend server 200 over the internet 110. No on-premises local server is required to perform any point-of-sale function within the establishment as all synchronization functions are performed through messages exchanged between the backend server 200 and the terminal 700. The terminal 700 may comprise a touchscreen 704 that allows for order entry, display of the virtual digital menu described herein, and related functions. The terminal 700 may also comprise input/output circuits 705 that include, but are not limited to, data entry and display devices (e.g., keyboards, monitors, touchpads, scanners, cameras, printers, etc.). The terminal 700 may further comprise a card entry interface 715 that staff may employ to enter direct or indirect payment authorization mechanisms data into the system. In one embodiment, the interface 715 comprises a conventional card reader that may provide for entry of card data via magnetic strip swipe, EMV chip reading (“dip”), or reading of encoded data via near field communications (“tap”). The interface 715 may be capable of one or more of the aforementioned mechanisms for reading card data. In one embodiment, the credit card interface 715 may be integrated into the same housing as the touchscreen 704. In one embodiment, the input/output circuits 705 may be employed to identify indirect transaction authorization mechanisms that are not readable by the card reader 315.

The memory 706 may include an operating system 707 such as, but not limited to, Microsoft Windows, Mac OS, Unix, and Linux, where the operating system 707 is configured to manage execution by the CPU 701 of program instructions that are part of components of one or more application programs. In one embodiment, a single application program comprises a plurality of code segments 708-710, 713 resident in the memory 706 and identified as a synchronization module (SYNC) 708, an order entry process (ORDER ENTRY) 709, a configuration process (CONFIG) 310, and a transaction process (TRANSACTION) 713. Other code segments (not shown) may be provided to perform other point-of-sale functions by the terminal 700 (e.g., printing of receipts, entry of gift cards, etc.) which are not discussed herein in order to clearly teach relevant aspects of the present invention.

Operationally, the CPU 701 may execute one or more of the modules708-710, 713 as required to display virtual digital, interactive menus according to the present invention that enable guests or servers in a retail establishment to initiate orders; to communicate orders to the backend server 200; to receive communications from the backend server 200 that synchronize an order taken by one POS terminal 700 with other POS terminals 700 in the establishment; to input direct and indirect payment authorization mechanisms.

The configuration module CONFIG 310 may be employed upon power up of the terminal 300 to configure the terminal 300 for a specific function such as a seating terminal, a self-serve kiosk, an order processing/fulfillment terminal, an expediter terminal, or a management feedback and action terminal. In one embodiment, CONFIG may enable restaurant staff to enable and disable dynamic rearrangement of element icon on the digital menu based upon ranking of historical orders by ORDER ANALYTICS 215.1-215.N.

ORDER ENTRY 709 may execute to display the digital virtual menu and to enable a guest/server to make selections for an order. As an order is entered, it is transmitted to the backend server 200 via messages over the links 703. SYNC 708 is executed to and works in conjunction with a corresponding ORDER SYNC module 213.1-213.N in the backend server 200 to maintain persistent and durable states of all orders within the establishment, even though those orders may have been entered on other terminals 700. Advantageously, this allows any terminal 700 within the establishment to modify and close out an existing order. In addition, this synchronization enables multiple terminals 700 to be employed to process a single order, say for a table of 20 guests, thus significantly reducing the time required to enter and fulfill orders, which comprises a remarkable improvement in transaction processing technology.

To close out an order, the transaction process 713 may be executed to provide for display of order details and subtotals, and to provide for entry of a direct or indirect payment authorization mechanism by a guest. If the mechanism is indirect, then the input/output circuits 305 are employed to capture the mechanism and payment data obtained from the mechanism is transmitted via the links 703 to the backend server 200. If the mechanism is a card-readable payment authorization mechanism, then the card-readable payment authorization mechanism is entered via the card interface 715 and transmitted via the links 303 to the backend server 200.

In turn, the backend server 200 may process payment for the order and send acknowledgement and receipt data to the terminal 700.

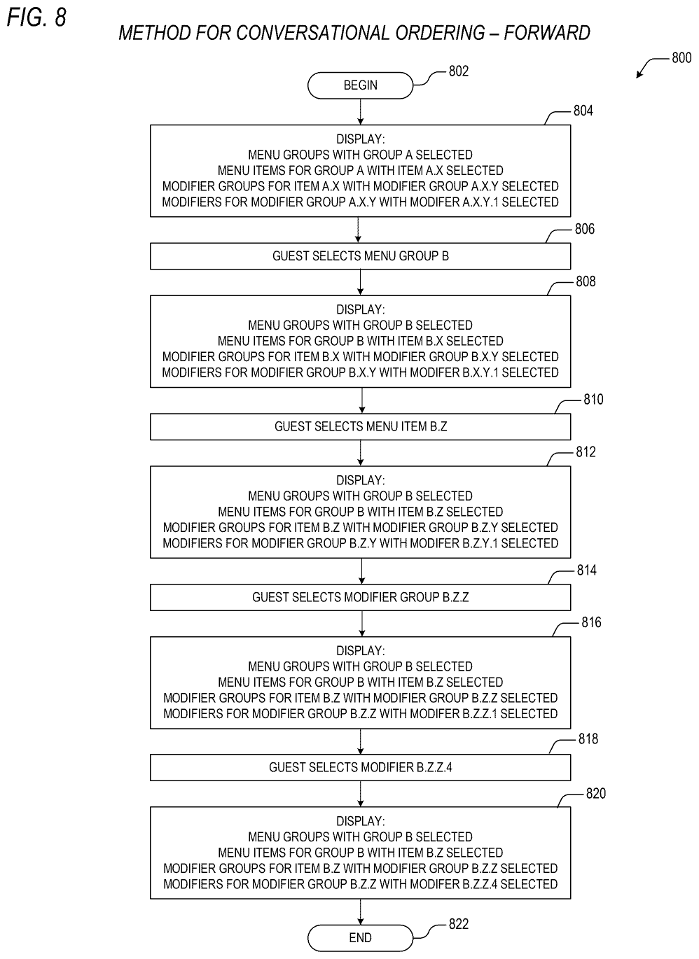

Referring to FIG. 8, a flow diagram 800 is presented illustrating a dynamic conversational menu display and ordering method according to the present invention as may be applied to a guest's forward conversational ordering manner. Flow begins at block 802 where a POS terminal 121, 123 as described above is employed to allow for entry of an order item by a guest or server. Flow then proceeds to block 804.

At block 804, a default (as entered by restaurant staff) virtual digital menu, such as the menu of FIG. 4, is displayed on a point-of-sale terminal 121, 123. Icons within each of the menu tiers (e.g., menu groups, menu subgroups, menu items, modifier groups, modifiers) are displayed. In this example, for clarity sake and to teach adaptability of the present invention to less complex menu hierarchies, no menu subgroups are present within the hierarchical menu. All menu groups (e.g., group A, group B, group C, etc.) are displayed with menu group A shown as being selected. Menu items (e.g., menu items A.X, A.Y, . . . ) corresponding to menu group A are displayed with menu item A.X shown as selected. Modifier groups (e.g., A.X.Y, A.X.Z, . . . ) corresponding to menu item A.X are displayed with modifier group A.X.Y shown as selected. And modifiers (A.X.Y.1, A.X.Y.2, . . . ) corresponding to modifier group A.X.Y are displayed with modifier A.X.Y.1 shown as selected. Essentially, the top row of menu tier icons comprising the digital virtual menu are shown as being selected. Flow then proceeds to block 806.

At block 806 a guest/server selects menu group B. Flow then proceeds to block 808.

At block 808, all menu groups (e.g., group A, group B, group C, etc.) are displayed with menu group B shown as being selected. Menu items (e.g., menu items B.X, B.Y, . . . ) corresponding to menu group B are displayed with menu item B.X shown as selected. Modifier groups (e.g., B.X.Y, B.X.Z, . . . ) corresponding to menu item B.X are displayed with modifier group B.X.Y shown as selected. And modifiers (B.X.Y.1, B.X.Y.2, . . . ) corresponding to modifier group B.X.Y are displayed with modifier B.X.Y.1 shown as selected. Flow then proceeds to block 810.

At block 810, the guest/server selects menu item B.Z. Flow then proceeds to block 812.

At block 812, all menu groups (e.g., group A, group B, group C, etc.) are displayed with menu group B shown as being selected. Menu items (e.g., menu items B.X, B.Y, . . . ) corresponding to menu group B are displayed with menu item B.Z shown as selected. Modifier groups (e.g., B.Z.Y, B.Z.Z, . . . ) corresponding to menu item B.Z are displayed with modifier group B.Z.Y shown as selected. And modifiers (B.Z.Y.1, B.Z.Y.2, . . . ) corresponding to modifier group B.Z.Y are displayed with modifier B.Z.Y.1 shown as selected. Flow then proceeds to block 814.

At block 814, the guest/server selects modifier group B.Z.Z Flow then proceeds to block 816.

At block 816, all menu groups (e.g., group A, group B, group C, etc.) are displayed with menu group B shown as being selected. Menu items (e.g., menu items B.X, B.Y, . . . ) corresponding to menu group B are displayed with menu item B.Z shown as selected. Modifier groups (e.g., B.Z.Y, B.Z.Z, . . . ) corresponding to menu item B.Z are displayed with modifier group B.Z.Z shown as selected. And modifiers (B.Z.Z.1, B.Z.Z.2, . . . ) corresponding to modifier group B.Z.Z are displayed with modifier B.Z.Z.1 shown as selected. Flow then proceeds to block 818.

At block 818, the guest/server selects modifier B.Z.Z.4 Flow then proceeds to block 820.

At block 820, all menu groups (e.g., group A, group B, group C, etc.) are displayed with menu group B shown as being selected. Menu items (e.g., menu items B.X, B.Y, . . . ) corresponding to menu group B are displayed with menu item B.Z shown as selected. Modifier groups (e.g., B.Z.Y, B.Z.Z, . . . ) corresponding to menu item B.Z are displayed with modifier group B.Z.Z shown as selected. And modifiers (B.Z.Z.1, B.Z.Z.2, . . . ) corresponding to modifier group B.Z.Z are displayed with modifier B.Z.Z.4 shown as selected. Flow then proceeds to block 822.

At block 822, the method completes.

As is described in particular with reference to FIG. 3, the system 100 according to the present invention contemplates additional menu hierarchy tiers over those disclosed above that include additional menu hierarchy tiers and a subset of the hierarchy tiers. In addition, embodiments of the present invention discussed with reference to FIG. 8 may modify certain steps to preclude display of the modifier group column and modifiers column until a menu item is selected from the menu item column. In addition, when a menu item icon is selected from within its menu item column, rather than displaying a modifier group column and a single modifier column showing modifiers for a selected modifier group element, the display would show multiple modifier columns corresponding to the selected menu item, where each of the modifier columns may comprise modifier elements within a corresponding modifier group.

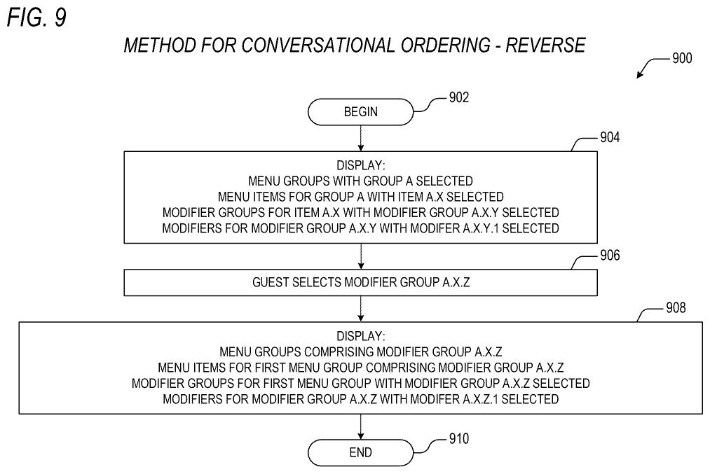

Now turning to FIG. 9, a flow diagram 900 is presented illustrating a dynamic conversational menu display and ordering method according to the present invention as may be applied to a guest's reverse conversational ordering manner. Flow begins at block 902 where a POS terminal 121, 123 as described above is employed to allow for entry of an order item by a guest or server. Flow then proceeds to block 904.

At block 904, a default (as entered by restaurant staff) virtual digital menu, such as the menu of FIG. 5, is displayed on a point-of-sale terminal 121, 123. Icons within each of the menu tiers (e.g., menu groups, menu subgroups, menu items, modifier groups, modifiers) are displayed. In this example, for clarity sake and to teach adaptability of the present invention to less complex menu hierarchies, no menu subgroups are present within the hierarchical menu. All menu groups (e.g., group A, group B, group C, etc.) are displayed with menu group A shown as being selected. Menu items (e.g., menu items A.X, A.Y, . . . ) corresponding to menu group A are displayed with menu item A.X shown as selected. Modifier groups (e.g., A.X.Y, A.X.Z, . . . ) corresponding to menu item A.X are displayed with modifier group A.X.Y shown as selected. And modifiers (A.X.Y.1, A.X.Y.2, . . . ) corresponding to modifier group A.X.Y are displayed with modifier A.X.Y.1 shown as selected. Flow then proceeds to block 906.

At block 906 a guest/server selects modifier group A.X.Z. Flow then proceeds to block 908.

At block 908, responsive to selection of modifier group A.X.Z by the guest/server, menu groups comprising modifier group A.X.Z are displayed with menu group A shown as being selected. Though according to the nomenclature employed herein modifier group A.X.Z corresponds to menu group A and menu item A.X, the present inventors note that modifier group A.X.Z may comprise menu groups other than menu group A and menu items other than menu item A.X. In addition, menu items for a first menu group (e.g., menu group A) comprising modifier group A.X.Z are displayed, modifier groups for the first menu group are displayed with modifier group A.X.Z shown as selected, and modifiers for modifier group A.X.Z are displayed with modifier A.X.Z.1 shown as selected. Flow then proceeds to block 910.

At block 910, the method completes. Advantageously, though a virtual digital hierarchical menu is initially displayed for selection by a guest/server, the guest/server may begin selection of an order item by selecting one or more modifiers, a modifier group, or a menu item, and the virtual display will adjust to display menu elements in higher hierarchical tiers that comprise the selected one or more modifiers, the modifier group, or the menu item, thus enabling an order to be placed in a conversational manner, thus enabling entry of an order item in a manner that is faster and more intuitive than that which has heretofore been provided.

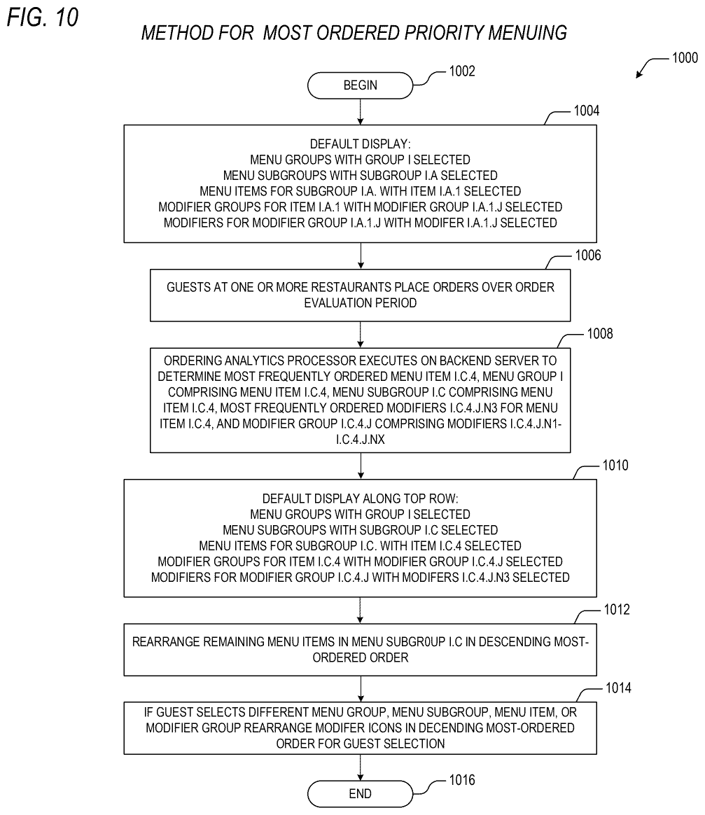

Finally referring to FIG. 10, a flow diagram 1000 featuring a dynamic conversational menu display and ordering method according to the present invention as modified via a processor's analysis of items most ordered from one or more corresponding restaurant menus. Flow begins at block 1002 where a POS terminal 121, 123 as described above is employed to allow for entry of an order item by a guest or server. Flow then proceeds to block 1004.

At block 1004, a default (as entered by restaurant staff) virtual digital menu, such as the menu of FIG. 6, is displayed on a point-of-sale terminal 121, 123. Icons within each of the menu tiers (e.g., menu groups, menu subgroups, menu items, modifier groups, modifiers) are displayed. In this example, menu subgroups are present within the hierarchical menu. All menu groups (e.g., group I, group II, group III, etc.) are displayed with menu group I shown as being selected. Menu subgroups (I.A, I.B, I.C, . . . ) corresponding to menu group I are shown with menu subgroup I.A selected. Menu items (e.g., menu items I.A.1, I.A.2, I.A.3, . . . ) corresponding to menu subgroup I.A are displayed with menu item I.A.1 shown as selected. Modifier groups (e.g., I.A.1.J, I.A. I.K, I.A.1.N, . . . ) corresponding to menu item I.A.1 are displayed with modifier group I.A.1.J shown as selected. And modifiers (I.A.1.J.N1-I.A.1 J.NX, . . . ) corresponding to modifier group I.A.I.J are displayed with modifier I.A.1.J.N1 shown as selected. Flow then proceeds to block 1006.

At block 1006 guests at one or more restaurants corresponding to the default virtual digital menu place orders as described above over a prescribed evaluation period, which are fulfilled by the one or more restaurants. In one embodiment, the one or more restaurants comprise a single restaurant that uses the default virtual digital menu. In another embodiment, the one or more restaurants comprise a chain of restaurants that employ the same default virtual digital menu. In yet another embodiment, the one or more restaurants comprise a group of restaurants within a prescribed geographic area that employ the same default virtual digital menu, where the prescribed geographic area may comprise, a town, a city, a metropolitan area, a county, a plurality of collocated counties, a country, or a plurality of countries. In a further embodiment, the one or more restaurants may comprise one or more similar restaurants that employ similar default virtual digital menus that are similar to the default virtual digital menu, where similarity of the similar default virtual digital menus relative to the default virtual digital menu is determined via execution of a transformer-based pre-trained deep learning model employing natural language pre-training, such as, but not limited to BERT. As one skilled in the art will also appreciate, BERT is a type of WORD2VEC model and is a pre-trained deep learning model that is better suited to short strings and that considers word sequence. Thus, because most restaurant menu items fall into the category of short strings having meaningful word sequences, the present inventors note that BERT is better suited for generation of vector representations of menu items for purposes of similarity determinations; however, any type of EMBEDDINGS model may be employed. This technique for determining similarity of menu items as noted herein is disclosed in U.S. patent application Ser. No. 17/245,324, entitled “DEEP LEARNING SYSTEM FOR DYNAMIC PREDICTION OF ORDER PREPARATION TIMES,” which is herein incorporated by reference in its entirety. In one embodiment, the prescribed evaluation period is 24 hours. Other embodiments contemplate evaluation periods of 1 week, 1 month, 3 months, 6 months, and 12 months. Flow then proceeds to block 1008.

At block 1008, the ORDER ANALYTICS module(s) 215.1-215.N corresponding to the one or more restaurants may execute at the end of the prescribed evaluation period to determine a most frequently ordered menu item and most order modifiers for the most frequently ordered menu item for each of the one or more restaurants. If more than one restaurant's order fulfilment is analyzed by ORDER ANALYTICS 215.1-215.N, then the most ordered menu items and modifiers for each of the more than one restaurants are aggregated to determine that most ordered menu item and its modifiers across all of the one or more restaurants and an aggregation of menu items and corresponding modifiers is ranked from most ordered to least ordered. A ranked aggregation of menu items and corresponding modifiers is shared to all MENU FLOW modules 214.1-214.N corresponding to the one or more restaurants that are evaluated. If a given restaurant within the one or more restaurants is configured to employ dynamic modification of its virtual digital menu, then the MENU FLOW 214.1-214.N for the given restaurant updates its digital virtual menu according to the ranked aggregation and an optimized virtual digital menu for the given restaurant is transmitted via COMMS 202 to the point-of-sale terminals 121, 123 in the given restaurant, where the optimized virtual digital menu for the given restaurant rearranges icons within each menu tier so that the most ordered element icons are displayed in most accessible positions on the display menu. In this example, ORDER ANALYTICS 215.1-215.N determines a ranking where a most ordered menu item and its most ordered modifier for the one or more restaurants is menu item I.C.4 and modifier I.C.4.J.N3. It is determined that menu item I.C.4 belongs to menu group I and menu subgroup C and modifiers I.C.4.J.N3 belongs to modifier group I.C.4.J. Flow then proceeds to block 1010.

At block 1010, the optimized virtual digital menu is displayed on the POS terminals 121, 123 in the one or more restaurants. In this example, the most accessible and prominent configuration places most ordered icons for elements in each of the menu tiers as the first selectable icon. In a landscape menu configuration that employs tier columns, the most ordered icons are placed at the top of the display. In a portrait menu configuration that employs tier rows, the most ordered icons are placed at the left of the display. Other embodiments are contemplated for dynamic rearrangement of menu icons. Accordingly, menu icons for the POS terminals 121, 123 are dynamically rearranged to display menu groups in ranked order with group I displayed and selected in the most prominent position. Likewise, menu subgroup I.C is displayed and selected in the menu subgroup tier's most prominent position. Menu item I.C.4 is displayed and selected in the menu item tier's most prominent position. Modifier group I.C.4.J is displayed and selected in the modifier group tier's most prominent position. And modifier I.C.4.J.N3 is displayed and selected in the modifier tier's most prominent position. Flow then proceeds to block 1012.

At block 1012, remaining menu items in menu subgroup I.C are rearranged and displayed according to the most ordered ranking previously determined. Flow then proceeds to block 1014.

At block 1014, if a guest/server selects a different menu group, menu subgroup, menu item, or modifier group, then the virtual menu displays the lower and upper menu tiers for corresponding to the selection according to the ranking previously determined. Flow then proceeds to block 1016.

At block 1016, the method completes.

Portions of the present invention and corresponding detailed description are presented in terms of software, or algorithms along with symbolic representations of operations on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” or “displaying” or the like, refer to the action and processes of a computer program product, a computer system, a microprocessor, a central processing unit, or similar electronic computing device, that manipulates and transforms data represented as physical, electronic quantities within the computer system's registers and memories into other data similarly represented as physical quantities within the computer system memories or registers or other such information storage, transmission or display devices. The devices may comprise one or more CPUs that are coupled to a computer-readable storage medium. Computer program instructions for these devices may be embodied in the computer-readable storage medium. When the instructions are executed by the one or more CPUs, they cause the devices to perform the above-noted functions, in addition to other functions.

Note also that the software implemented aspects of the invention are typically encoded on some form of program storage medium or implemented over some type of transmission medium. The program storage medium may be electronic (e.g., read only memory, flash read only memory, electrically programmable read only memory), random access memory magnetic (e.g., a floppy disk or a hard drive) or optical (e.g., a compact disk read only memory, or “CD ROM”), and may be read only or random access. Similarly, the transmission medium may be metal traces, twisted wire pairs, coaxial cable, optical fiber, or some other suitable transmission medium known to the art. The invention is not limited by these aspects of any given implementation.

The particular disclosed above are illustrative only, and those skilled in the art will appreciate that they can readily use the disclosed conception and specific embodiments as a basis for designing or modifying other structures for carrying out the same purposes of the present invention, and that various changes, substitutions and alterations can be made herein without departing from the scope of the invention as set forth by the appended claims. For example, components/elements of the systems and/or apparatuses may be integrated or separated. In addition, the operation of the systems and apparatuses disclosed herein may be performed by more, fewer, or other components and the methods described may include more, fewer, or other steps. Additionally, unless otherwise specified steps may be performed in any suitable order.

Although specific advantages have been enumerated above, various embodiments may include some, none, or all of the enumerated advantages.

1. A computer-implemented method for displaying a digital menu on a point-of-sale (POS) device, the method comprising:
on a touchscreen display of the POS device, displaying first selectable icons as a single virtual page, wherein:
the first selectable icons correspond to menu tier elements in menu tiers according to a menu tier hierarchy; and
the touchscreen display comprises scrolling mechanisms to display one or more of the first selectable icons that are not initially visible on the single virtual page;
selecting one of the first selectable icons in a first menu tier for an order, wherein the first menu tier is not a highest-level tier in the menu tier hierarchy; and
responsive to selection of the one of the first selectable icons, modifying the single virtual page by replacing one or more of the first selectable icons in higher-level and lower-level menu tiers relative to the first menu tier with second selectable icons that correspond to the one of the first selectable icons in the menu tier hierarchy.

2. The computer-implemented method as recited in claim 1, wherein the menu tiers comprise, in descending hierarchical order:
a menu group;
a menu subgroup;
a menu item;
a modifier group; and
modifiers.

3. The computer-implemented method as recited in claim 1, wherein the scrolling mechanisms comprise:
a touchscreen interface that allows the single virtual page to be swiped to display the one or more of the first selectable icons that are not initially visible;
a swipe control icon that may be selected to display the one or more of the first selectable icons that are not initially visible; and
a plurality of display screen markers that indicate a current display screen relative to remaining display screens within the digital virtual menu.

4. The computer-implemented method as recited in claim 3, further comprising:
employing one of the scrolling mechanisms to display the one or more of the first selectable icons that are not initially visible on the single virtual page.

5. The computer-implemented method as recited in claim 1, wherein:
the single virtual page is displayed in landscape orientation; and
the scrolling mechanisms enable the single virtual page to be scrolled from right to left and from left to right.

6. The computer-implemented method as recited in claim 1, wherein:
the single virtual page is displayed in portrait orientation; and
the scrolling mechanisms enable the virtual page to be scrolled from top to bottom and from bottom to top.

7. The computer-implemented method as recited in claim 1, further comprising:
responsive to selection of the one of the first selectable icons, determining which ones of the first and second selectable icons cannot be selected due to menu tier restrictions or depleted inventory;
displaying the ones of the first and second selectable icons that cannot be selected so that they contrast with selectable ones of the first and second selectable icons; and
disabling touch selection of the ones of the first and second selectable icons that cannot be selected.

8. A computer-readable storage medium storing instructions that, when executed by a computer, cause the computer to perform a method for displaying a digital menu on a point-of-sale (POS) device, the method comprising:
on a touchscreen display of the POS device, displaying first selectable icons as a single virtual page, wherein:
the first selectable icons correspond to menu tier elements in menu tiers according to a menu tier hierarchy; and
the touchscreen display comprises scrolling mechanisms to display one or more of the first selectable icons that are not initially visible on the single virtual page;
selecting one of the first selectable icons in a first menu tier for an order, wherein the first menu tier is not a highest-level tier in the menu tier hierarchy; and
responsive to selection of the one of the first selectable icons, modifying the single virtual page by replacing one or more of the first selectable icons in higher-level and lower-level menu tiers relative to the first menu tier with second selectable icons that correspond to the one of the first selectable icons in the menu tier hierarchy.

9. The computer-readable storage medium as recited in claim 8, wherein the menu tiers comprise, in descending hierarchical order:
a menu group;
a menu subgroup;
a menu item;
a modifier group; and
modifiers.

10. The computer-readable storage medium as recited in claim 8, wherein the scrolling mechanisms comprise:
a touchscreen interface that allows the single virtual page to be swiped to display the one or more of the first selectable icons that are not initially visible;
a swipe control icon that may be selected to display the one or more of the first selectable icons that are not initially visible; and
a plurality of display screen markers that indicate a current display screen relative to remaining display screens within the digital virtual menu.

11. The computer-readable storage medium as recited in claim 10, further comprising:
employing one of the scrolling mechanisms to display the one or more of the first selectable icons that are not initially visible on the single virtual page.

12. The computer-readable storage medium as recited in claim 8, wherein:
the single virtual page is displayed in landscape orientation; and
the scrolling mechanisms enable the single virtual page to be scrolled from right to left and from left to right.

13. The computer-readable storage medium as recited in claim 8, wherein:
the single virtual page is displayed in portrait orientation; and
the scrolling mechanisms enable the virtual page to be scrolled from top to bottom and from bottom to top.

14. The computer-readable storage medium as recited in claim 8, further comprising:
responsive to selection of the one of the first selectable icons, determining which ones of the first and second selectable icons cannot be selected due to menu tier restrictions or depleted inventory;
displaying the ones of the first and second selectable icons that cannot be selected so that they contrast with selectable ones of the first and second selectable icons; and
disabling touch selection of the ones of the first and second selectable icons that cannot be selected.

15. A computer program product for displaying a digital menu on a point-of-sale (POS) device, the computer program product comprising:
a computer readable non-transitory storage medium having computer readable program code stored thereon, the computer readable program code comprising:
program instructions to, on a touchscreen display of the POS device, display first selectable icons as a single virtual page, wherein:
the first selectable icons correspond to menu tier elements in menu tiers according to a menu tier hierarchy; and
the touchscreen display comprises scrolling mechanisms to display one or more of the first selectable icons that are not initially visible on the single virtual page;
program instructions to select one of the first selectable icons in a first menu tier for an order, wherein the first menu tier is not a highest-level tier in the menu tier hierarchy; and
program instructions to, responsive to selection of the one of the first selectable icons, modify the single virtual page by replacing one or more of the first selectable icons in higher-level and lower-level menu tiers relative to the first menu tier with second selectable icons that correspond to the one of the first selectable icons in the menu tier hierarchy.

16. The computer program product as recited in claim 15, wherein the scrolling mechanisms comprise:
a touchscreen interface that allows the single virtual page to be swiped to display the one or more of the first selectable icons that are not initially visible;
a swipe control icon that may be selected to display the one or more of the first selectable icons that are not initially visible; and
a plurality of display screen markers that indicate a current display screen relative to remaining display screens within the digital virtual menu.

17. The computer program product as recited in claim 16, further comprising:
program instructions to employ one of the scrolling mechanisms to display the one or more of the first selectable icons that are not initially visible on the single virtual page.

18. The computer program product as recited in claim 15, wherein:
the single virtual page is displayed in landscape orientation; and
the scrolling mechanisms enable the single virtual page to be scrolled from right to left and from left to right.

19. The computer program product as recited in claim 15, wherein:
the single virtual page is displayed in portrait orientation; and
the scrolling mechanisms enable the virtual page to be scrolled from top to bottom and from bottom to top.

20. The computer program product as recited in claim 15, further comprising:
program instructions to:
responsive to selection of the one of the first selectable icons, determine which ones of the first and second selectable icons cannot be selected due to menu tier restrictions or depleted inventory;
display the ones of the first and second selectable icons that cannot be selected so that they contrast with selectable ones of the first and second selectable icons; and
disable touch selection of the ones of the first and second selectable icons that cannot be selected.
